(19) United States
(12) Patent Application Publication
(10) Pub. No.: US 2026/0021586 A1
(43) Pub. Date: Jan. 22, 2026

(54) COORDINATE POSITIONING MACHINE

(71) Applicant: RENISHAW PLC, Wotton-under-Edge, Gloucestershire (GB)

(72) Inventors: Julius Benjamin DUPREZ, Marne la Vallée (FR); Jean-Louis GRZESIAK, Marne la Vallée (FR)

(73) Assignee: RENISHAW PLC, Wotton-under-Edge, Gloucestershire (GB)

(21) Appl. No.: 18/996,058

(22) PCT Filed: Jul. 28, 2023
(86) PCT No.: PCT/EP2023/071021

§ 371 Date: Jan. 17, 2025

(30) Foreign Application Priority Data
Jul. 28, 2022 (FR) FR2207810

(51) Int. Cl. B25J 9/16

(52) U.S. Cl. CPC B25J 9/1692; B25J 9/1605; B25J 9/1664

(57) ABSTRACT

A method of recovering a master calibration state of a coordinate positioning machine has a first member that is moveable relative to a second member, wherein the geometry of the machine is characterised by a set of model parameters. The machine is controlled to make point contact between multiple reference surfaces of a tool mounted on the first member and multiple reference surfaces of an artefact mounted on the second member. The separations between these contacting surfaces that would be expected from the current model parameters are determined, and these separations are recorded as a set of master separations. The contacting step is subsequently performed again in respect of at least some of the contacts for which master separations were recorded. At least one of the model parameters is updated to provide a closer correspondence between the expected separations and the master separations.

The present invention relates to a coordinate positioning machine. The present invention relates in particular, but not exclusively, to a system for calibrating or otherwise characterising at least some aspect of a coordinate positioning machine. The present invention is particularly applicable, for example, to a non-Cartesian type of coordinate positioning machine, such as a hexapod, measurement arm or articulated robot.

Articulated robots are commonly used in a wide variety of manufacturing applications such as assembly, welding, gluing, painting, picking and placing (e.g. for printed circuit boards), packaging and labelling, palletizing, and product inspection. They benefit from being versatile and rugged, with a large reach and a high degree of flexibility of movement, making them ideal for use in a production environment.

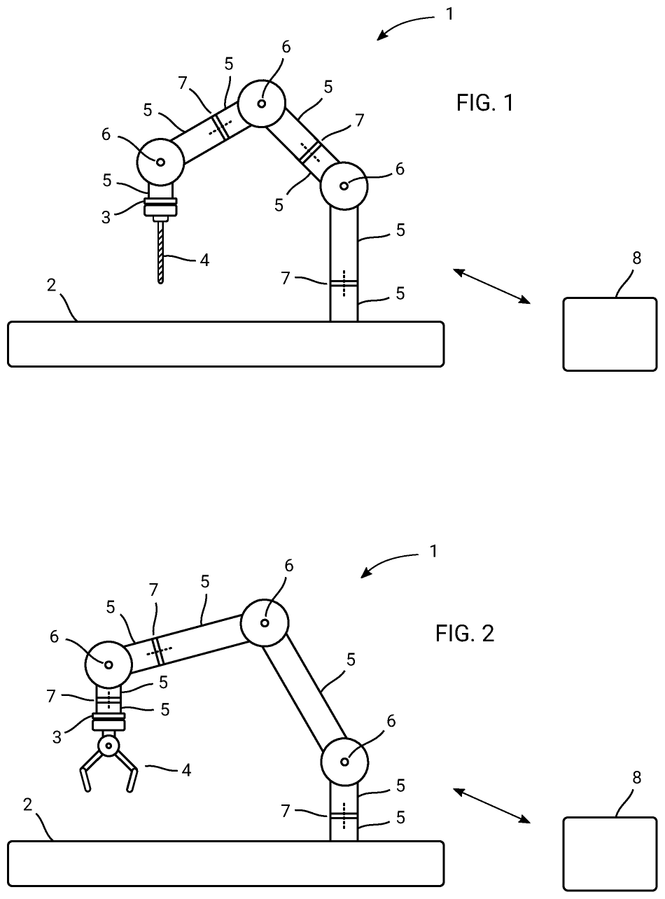

An articulated robot (or just “robot” for short) is illustrated schematically in FIG. 1 of the accompanying drawings, comprising an articulated robot arm 1 extending from a fixed base 2 to a moveable flange 3, with the flange 3 supporting a tool (or end effector) 4. The tool 4 in FIG. 1 is a drilling tool. Typically, the flange 3 is provided with a coupling which allows for the tool 4 to be conveniently interchangeable, so that a variety of tools or end effectors can be employed depending on the application concerned; examples include grippers, vacuum cups, cutting tools (including both mechanical and laser cutting tools), drilling tools, milling tools, deburring tools, welding tools and other specialized tools. The flange 3 can also be referred to more generally as the “head” of the robot arm 1, with the fixed base 2 being the “base” and with the robot arm 1 being controlled to move the head relative to the base by commands from a machine controller 8. The flange 3 is also sometimes referred to as the “hand” of the robot arm 1.

The arm 1 comprises a plurality of segments 5 connected by a mixture of transverse rotary axes 6 and inline (or longitudinal) rotary axes 7, forming a mechanical linkage from one end to the other. In the example illustrated in FIG. 1, there are three transverse rotary axes 6 and three inline rotary axes 7, making a total of six rotary axes, alternating between transverse rotary axes 6 and inline rotary axes 7. An additional inline rotary axis 7 (not shown in FIG. 1) could also be provided between the final transverse rotary axes 6 and the flange 3, to provide convenient rotation of the tool 4 around its longitudinal axis, making a total of seven rotary axes. In general, rotary axes of a robot need not be exactly orthogonal or exactly longitudinal but can be arranged at any desired angle.

Another common arrangement is shown in the arm 1 of FIG. 2, which includes the additional inline rotary axis 7 mentioned above, between the final transverse rotary axis 6 and the flange 3, and which also omits the second inline rotary axis 7 from FIG. 1 (in series order from the base end to the head end), thereby making a total of six rotary axes. The tool 4 in FIG. 2 is a gripper. The arm 1 of FIG. 2 is a schematic representation of the well-known IRB 140 six-axis industrial robot by ABB Robotics. The final three axes 6, 7 form a “wrist” of the robot arm 1, with the centre of the wrist being at the centre of the final transverse rotary axis 6. The centre of the wrist is invariant to rotation of the three rotary axes 6, 7 of the wrist, such that operation of the three rotary axes 6, 7 changes the orientation of whatever is attached to the wrist (in this case the gripper 4) without changing the position of the wrist centre, with the first three rotary axes 6, 7 of the robot arm 1 determining the position of the wrist centre. The wrist may be readily detachable from the remainder of the arm 1.

The articulated robot arms 1 of FIGS. 1 and 2 are examples of a non-Cartesian coordinate positioning machine because, in contrast to a Cartesian machine such as a traditional three-axis (X, Y, Z) coordinate measuring machine (see for example FIG. 1 of PCT/GB2020/052593), its axes are not arranged orthogonally according to a Cartesian coordinate system. The arms 1 of FIGS. 1 and 2 are also examples of a “serial kinematic” coordinate positioning machine, because their axes of movement are arranged in series. In this sense, such a machine is similar to a traditional three-axis Cartesian coordinate measuring machine, which is also an example of a “serial kinematic” coordinate measuring machine, and is to be contrasted with a “parallel kinematic” coordinate positioning machine such as a hexapod whose axes of movement are arranged instead in parallel.

Each joint or axis in a coordinate positioning machine contributes a positional error or uncertainty. In a serial kinematic machine such as that shown in FIGS. 1 and 2, because of the serial nature of the linkages, these errors are cumulative. Whilst this accumulation of positional errors does not occur in the same sense with a parallel kinematic machine, regardless of machine type it is important to calibrate the machine in order to map out these errors or uncertainties.

Calibration of any type of non-Cartesian machine is a significant challenge, and particularly so for an articulated arm such as that illustrated in FIGS. 1 and 2 having a plurality of rotary axes that are: (a) arranged in series; (b) are not fixed relative to one another; and (c) that can combine in complicated ways to position the tool in the working volume. Calibration of a Cartesian machine is typically more straightforward, because such a machine has three well-defined axes that are fixed relative to one another in an orthogonal arrangement, with each axis being largely independent of another. With an articulated robot, the position and orientation of each axis depends on the position and orientation of each other axis, so that the calibration will be different for each different machine pose.

Many calibration techniques have in common the goal of specifying a parametric model of the machine concerned, in which a set of model parameters (also referred to as machine parameters) is used to characterise the machine's geometry. Uncalibrated values are initially assigned to these parameters as a starting point for the machine geometry. During the calibration, the machine is moved into a variety of different poses (based on the current estimates of the machine parameters). For each pose, a calibrated measuring device is used to measure the actual pose, so that an indication of the error between the assumed machine pose and the actual machine pose can be determined.

The task of calibrating the machine then amounts to determining a set of values for the various machine parameters that minimises the errors, using known numerical optimisation or error minimisation techniques. An example of such a technique is the well-known Levenberg-Marquardt algorithm, which uses a least-squares approach to minimise errors knowing the derivatives of the errors according to each parameter optimised (“A Method for the Solution of Certain Non-Linear Problems in Least Squares”, Kenneth Levenberg, 1944, Quarterly of Applied Mathematics, 2: 164-168; and “An Algorithm for Least-Squares Estimation of Nonlinear Parameters”, Donald Marquardt, 1963, SIAM Journal on Applied Mathematics, 11 (2): 431-441). Other techniques are also possible, including those based on a maximum likelihood approach.

For a robot arm as illustrated in FIGS. 1 and 2, these machine parameters might include various geometrical parameters such as the length of each of the segments 5 and the rotation angle offset of each of the rotary axes or joints 6, 7 (with the angle from the encoder plus the calibrated offset giving the actual angle), as well as various mechanical parameters such as joint compliance and friction. The machine parameters might also include the offset coordinates of the working point of the tool, such as the tip of the drilling tool 4 of FIG. 1, relative to the head or flange 3. In this respect, the offset of the working point (or tool centre point) is an important piece of information, and this will be discussed in more detail below.

When properly calibrated, with all of these machine parameters known, it is possible to predict with more certainty in what position the working point (or tool centre point) of the tool 4 will actually be when the various axes or joints 6, 7 are commanded by the controller 8 to move to different respective positions. In other words, the machine parameters resulting from such a calibration provide a more accurate characterisation of the machine geometry. These concepts, relating to calibration of coordinate positioning machines in general, and robot arms in particular, are explored in greater detail in WO 2019/162697 A1 and WO 2021/116685 A1.

However, challenges associated with calibrating a non-Cartesian machine such as described above remain, and it is desirable to find an improved method of and system for calibrating or otherwise characterising such a non-Cartesian coordinate positioning machine. Such a method and system can also find more general applicability to other types of coordinate positioning machine.

According to a first aspect of the present invention there is provided a method of recovering or returning to a master (or reference) calibration state (or state of characterisation) of a coordinate positioning machine (for example a robot) having a first member (for example a flange or spindle or moving platform) that is moveable relative to a second member (for example a fixed platform). The geometry of the machine is characterised by a set of model parameters. In step (a), the machine is controlled to make (point) contact between multiple (different and/or distinct) reference surfaces of a tool mounted on the first member and multiple (different and/or distinct) reference surfaces of an artefact mounted on the second member. In step (b), the corresponding separations (between the contacting surfaces) which would be expected (or derived) from the current model parameters are determined, or at least a set of separation values is determined which represents and/or is related to the expected separations, knowing that the actual separations are zero. A separation in this context may be considered to be the shortest distance between the contacting surfaces. These separation values can also be referred to as error values. These separation (or error) values are recorded as a set of master (or reference) separation (or error) values, or at least information is recorded from which the separation (or error) values can be derived. This can be considered to represent and/or characterise a master (or reference) calibration state. It is noted that a separation in this context may be defined on any suitable basis, whether it be centre to centre (e.g. of a spherical reference surface which is contacting the other reference surface) or an actual surface to surface distance, or any other value that is related to or dependent on the separation.

This set of master separations (or error values) is used subsequently to update (or recover) at least one of the model parameters. For example in step (c), which may be performed for example after a period of use in which some drift may have occurred to one of more of the model parameters, step (a) may be repeated in respect of the same or corresponding contacts for which separations were recorded in step (b), or at least in respect of a subset of those contacts (because more parameters may be recorded at master than are used at recovery). In step (d), at least one of the model parameters may be updated (recovered) to provide a closer correspondence to the master (or reference) separations (or errors) recorded in step (b). In other words, an updated set of model parameters may be determined which would give a closer correspondence between the separations (or errors) expected (or derived) from the updated model parameters and the earlier master (or reference) separations (or errors).

Such a method thereby provides a convenient way of recovering or returning to, or at least moving closer to, the earlier master (or reference) calibration state.

The method may also comprise identifying the position of the artefact and/or some other parameters associated with the artefact and/or the machine.

The at least one model parameter may be or may comprise the tool centre point of the tool.

An at least nominal geometric model of the tool and/or the artefact may be used in step (b) to determine or derive the separations.

The master calibration state, as recorded or represented in step (b), may be a known good (or at least acceptable) calibration state of the machine, or a calibration state where it is known that the production is good or at least acceptable.

Rather than performing step (a) again in full as a result of step (c), i.e. in respect of all contacts for which separations were recorded previously in step (b), step (a) may first be performed in respect of a subset of those contacts and associated separations. Step (a) may then be completed in respect of the full set of contacts, and then continuing to step (d) to update the at least one model parameter, only if some measure of a variation or change in the associated separations determined from the subsequent performance of step (a), compared to the master separations recorded previously in step (b), is determined to be above a predetermined threshold or level.

The tool may have a defined and/or identifiable axis, for example a longitudinal axis. The tool may be an elongate tool having a defined and/or identifiable axis, for example a longitudinal axis.

An end surface of the tool may be spherical, at least where contact is made with the artefact.

A side surface of the tool may be cylindrical, at least where contact is made with the artefact.

A side surface of the tool may be axially symmetric in a single rotational axis (a single revolute axis), so that it could for example be cylindrical or conical, at least where contact is made with the artefact.

A top surface of the artefact may be planar, at least where contact is made with the tool.

A side surface of the artefact may be planar, at least where contact is made with the tool.

The method may comprise using an at least nominal geometric model representing the geometry of the tool and/or the artefact in step (b) and/or step (d).

The method may comprise using calibrated dimensional measurements of the artefact (for example from an independent and/or calibrated coordinate measuring machine) in step (b) and/or step (d).

The reference surfaces of the artefact may be metrological surfaces. A metrological surface in this context may be considered to be one that is accurate in a metrology sense, for example planar or spherical to within a predetermined accuracy and/or acceptable for use as a reference surface in a metrology method.

The method may comprise sensing contact between the tool and the artefact using a sensor.

The sensor may be mounted on the second member.

The sensor may be a contact sensor having a deflectable stylus and a contacting member for contacting an object being sensed.

The artefact may be used as the contacting member of the contact sensor.

The sensor may be a touch probe or a tool setter.

The artefact may comprise a cuboidal feature defining a plurality of planar reference surfaces and a cylindrical feature defining a cylindrical reference surface.

The tool may comprise a plurality of cylindrical features defining a corresponding plurality of cylindrical reference surfaces.

The tool may comprise a spherical feature defining a spherical reference surface.

Step (a) may comprise moving the first and second members relative to one another to bring (in turn) a plurality of different pairs of reference surfaces into point contact one another.

The coordinate positioning machine may be operable in step (a) to move the first member relative to the second member in six degrees of freedom.

At least one of the surfaces of the tool and/or the artefact may be a revolute surface. A revolute surface in this context may be considered as a surface that is rotationally or axially symmetric about a rotational or symmetry axis, or about an axis of curvature.

The revolute surface may have at least one revolute axis (or axis of rotational symmetry), for example as would be the case for a cylindrical surface.

The revolute surface may have at least two revolute axes (for example two revolute surfaces, for example as would be the case for a spherical surface.

Calibrating or otherwise characterising the machine may comprise one or more of calibrating, verifying, certifying and checking the performance of the machine.

The coordinate positioning machine may be a non-Cartesian and/or parallel kinematic machine.

The coordinate positioning machine may be a serial kinematic machine. The coordinate positioning machine may be an articulated arm (for example a robot arm). The coordinate positioning machine may have a plurality of rotary actuators arranged in series.

The coordinate positioning machine may be a hexapod. The coordinate positioning machine may have six linear actuators arranged in parallel.

The first member may be a moving member of the machine, such as an end effector or spindle or flange of a robot arm.

The second member may be a fixed member of the machine, such as a fixed platform or bed, or the base member of a serial kinematic machine such as a robot arm.

The artefact may be a calibration artefact. An artefact may be considered to be a calibration artefact in this context when it has for example been measured by an independent and/or calibrated coordinate measuring machine and/or machined to within a predetermined and/or acceptable tolerance.

Step (d) may comprise determining a new value or new values for only a subset of the model parameters.

The model parameters may comprise a plurality of tool frame parameters (defining a tool frame). Step (d) may comprise updating at least three of the tool frame parameters. Step (d) may comprise updating three tool frame parameters defining the position of a point of interest of the tool frame such as a tool centre point. Step (d) may comprise updating five tool frame parameters defining the position and orientation of an axis of the tool frame. Step (d) may comprise updating six tool frame parameters defining the full coordinate system of the tool frame.

According to a second aspect of the present invention, there is provided a method of recovering the tool frame (e.g. tool centre point) of a tool mounted to a coordinate positioning machine such as a robot arm, comprising performing a method according to the first aspect of the present invention, and wherein step (e) comprises recovering (one or more parameters of) the tool frame (e.g. tool centre point) from the previous calibration state.

According to a third aspect of the present invention, there is provided a computer program which, when run by a computer or a machine controller, causes the computer or machine controller to perform one or more steps of a method according to the first or second aspect of the present invention.

According to a fourth aspect of the present invention, there is provided computer-readable medium having stored therein computer program instructions for controlling a computer or a machine controller to perform one or more steps of a method according to the first or second aspect of the present invention.

According to a fifth aspect of the present invention, there is provided computer or machine controller configured to perform one or more steps of a method according to the first or second aspect of the present invention.

According to a sixth aspect of the present invention, there is provided system for calibrating or otherwise characterising a coordinate positioning machine comprising means for performing one or more steps of a method according to the first or second aspect of the present invention, or a computer program according to the third aspect of the present invention, or a computer-readable medium according to the fourth aspect of the present invention, or a computer or machine according to the fifth aspect of the present invention.

According to a seventh aspect of the present invention, there is provided method of controlling a coordinate positioning machine which has been calibrated or otherwise characterised using a method according to the first or second aspect of the present invention.

According to an eighth aspect of the present invention, there is provided coordinate positioning machine which has been calibrated or otherwise characterised using a method according to the first or second aspect of the present invention.

Reference will now be made, by way of example, to the accompanying drawings, in which:

FIG. 1, discussed hereinbefore, is a schematic illustration of a coordinate positioning arm in the form of an articulated robot, and carrying a drilling tool;

FIG. 2, also discussed hereinbefore, is a schematic illustration of an articulated robot having a different arrangement of rotary axes to that of FIG. 1, and carrying a gripping tool;

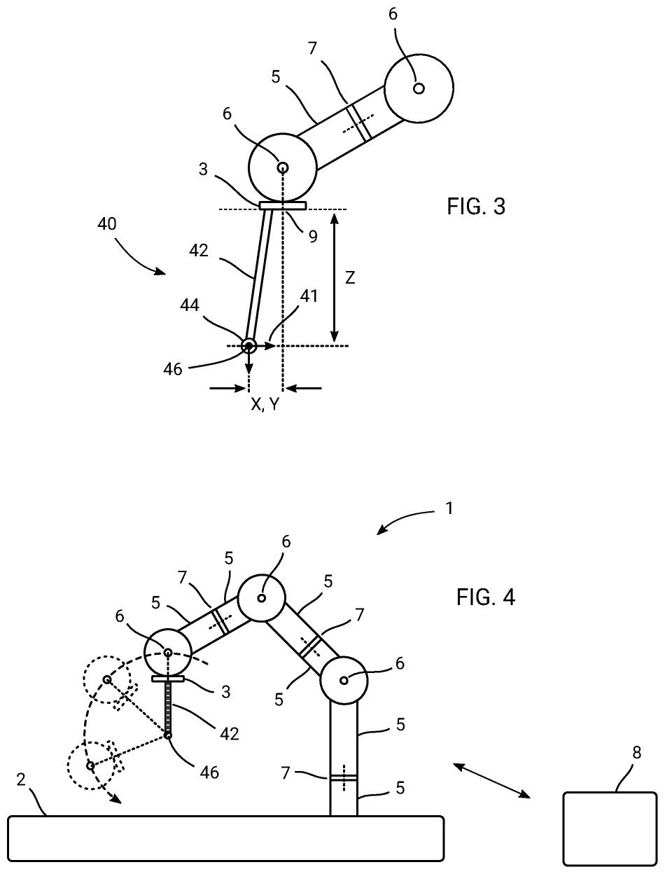

FIG. 3 is a schematic diagram for use in illustrating and describing in more detail the concept of a tool centre point and a tool frame;

FIG. 4 schematically illustrates a robot moving an attached tool in such a way that the tool centre point should remain in the same position;

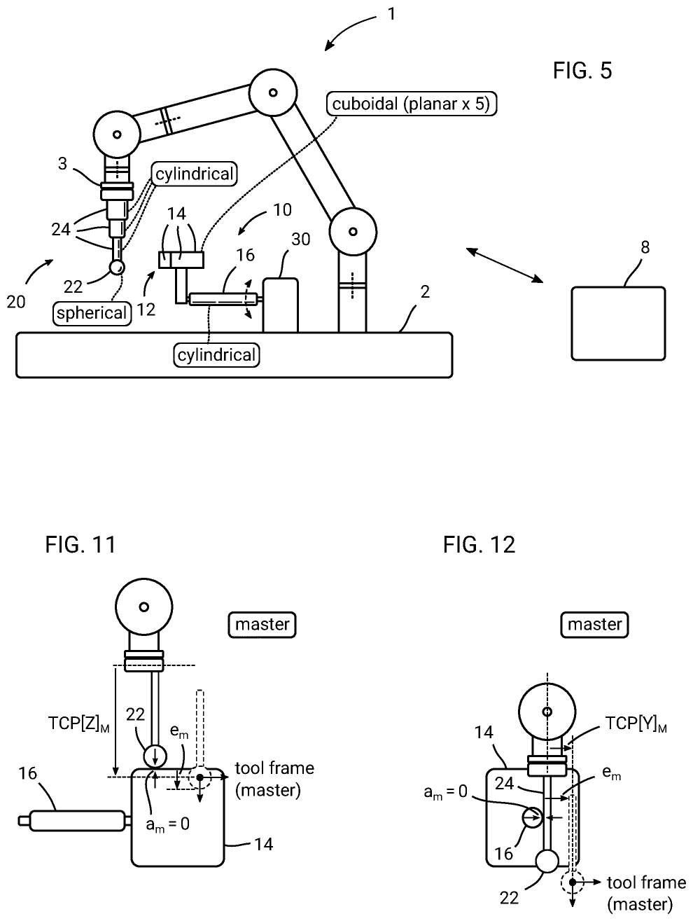

FIGS. 5, 6 and 7 are for use in explaining an embodiment of the present invention;

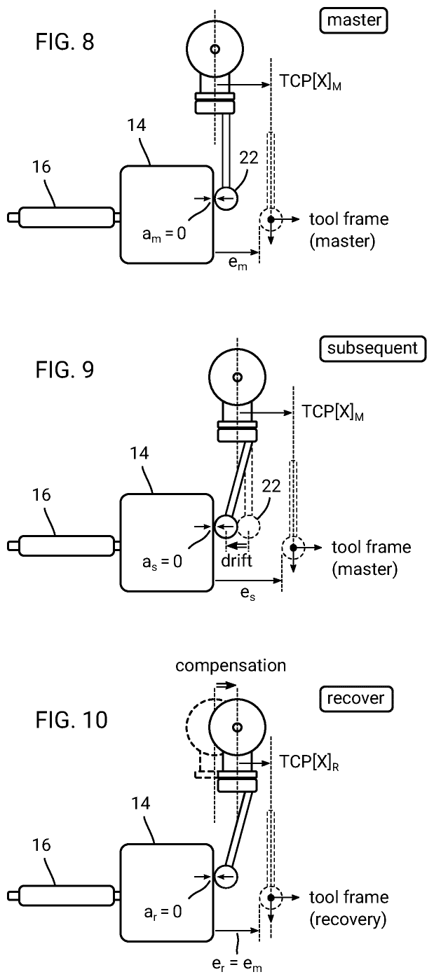

FIGS. 8, 9 and 10 are schematic front views for explaining in conceptual terms the master, subsequent and recovery stages respectively of a method embodying the present invention, for a representative one of the contact points made in an X direction;

FIG. 11 is a schematic front view corresponding to FIG. 8 but for a representative one of the contact points made in a Z direction; and

FIG. 12 is a schematic left side view corresponding to FIGS. 8 and 11 but for a representative one of the contact points made in a Y direction.

FIG. 3 shows a schematic representation of a tool 40 attached to a flange 3 of a robot arm of a type as described above with reference to FIGS. 1 and 2. The tool 40 has an elongate member 42 that is mounted at an angle to the flange 3 (the mounting angle may be deliberate or it could be inadvertent), with a tip 44 at a distal end of the elongate member 42. The centre 46 of the tip 44 is a particular point of interest because it would typically be the working point of the tool 40, or some other important reference point associated with the tool 40, and in a robot architecture this is commonly referred to as the tool centre point or TCP of the tool 40.

When programming a robot to move the tool 40 around the working volume, the location of the tool centre point 46 relative to the part of the robot to which the tool 40 is attached, i.e. the flange 3 in this case, is an important piece of information. Specifying the coordinates or offset (X, Y, Z) of the tool centre point 46 is a key step when setting up any robot for operational use. The tool centre point 46 is the point in relation to which all robot positioning is defined, and constitutes the origin of the tool frame (or tool coordinate system) 41 which is discussed in more detail below. The tool centre point 46 might correspond, for example, to the tip of an arc welding gun, the centre of a spot welding gun, the end of a grading tool, or the tip of a drilling tool such as that shown in FIG. 1. The location of the tool centre point 46 will therefore depend on the application concerned.

It is to be noted that knowledge of the coordinates or offset of the tool centre point 46 does not imply knowledge of the orientation of the tool 40 relative to the flange 3, nor does it imply knowledge of the length of the tool 40, because the tool centre point 46 is defined relative to an arbitrary point 9 on the flange 3 that is known and defined internally, and this does not necessarily correspond to the point at which the elongate member or shaft 42 of the tool 40 is actually attached to the flange 3, as indeed is the case in the schematic example shown in FIG. 3. Therefore, determining the tool centre point 46 of the tool 40 is not the same as, and does not amount to, determining the orientation or direction or length or size of the tool 40.

In operation, it is the tool centre point 46 that will be jogged around or moved to the desired target position with the desired tool orientation. For example, with reference to the “wrist” concept for a robot arm of a type as described above with reference to FIG. 2, the first three rotary axes of the robot arm can be controlled to set the position of the wrist centre, the three rotary axes of the wrist can be used to change the orientation of the flange 3 relative to the first three axes, and the position of the key point of the working tool 40 relative to the flange 3 can be determined from the tool centre point (TCP) information. By knowing and controlling these aspects of the robot architecture, the position of the working point 46 of the tool 40 can be controlled in a relatively straightforward manner.

FIG. 4 schematically illustrates the robot arm 1 being instructed by the controller 8 to move the tool 40 so that the tool centre point 46 of the tool 40 remains in the same position, or at least should ideally remain in the same position. Such a test is typically performed to verify that the tool centre point 46 has been correctly identified and is sometimes known as a “tool orientation test”. The objective is to assess the robot's accuracy (and the accuracy of the coordinates X, Y, Z of the tool centre point 46 as shown in FIG. 3) by measuring its ability to rotate around the tool centre point 46 that is programmed into the controller 8, ideally without any actual movement of the tool centre point 46 being apparent when the test is being performed.

Rather than merely verify the position of the TCP as is done with the tool orientation test, several methods exist for determining the absolute position of the TCP. The most common method currently is the pin-to-pin method in which the operator visually aligns two pins with different orientations, one of which is fixed on the machine base and the other of which is moveable by the robot to reference the TCP, with the robot being controlled manually by an operator. This is a convenient method, but it is relatively inaccurate because it depends to a large extent on the skill and experience of the operator; it also requires the tool 40 to be removed and replaced by the pin. Other known methods can be very costly to implement, such as those that make use of non-contact measurement systems like a camera-based system, a laser scanner, and so on, or measuring the robot tool with a touch probe. Those methods are of a type to determine values for the TCP coordinates as part of a full calibration of the robot, including the TCP offset.

Also represented in FIG. 3 is a tool frame 41, and in this respect it should be noted that a distinction should be drawn between the tool centre point (TCP) 46 and the tool frame 41. Whilst the tool centre point 46 is a significant point of interest within the tool frame 41 (it is the origin of the tool frame 41 as mentioned above), it is defined in only three degrees of freedom (by a set of X, Y, Z coordinates) and therefore does not itself completely define the tool frame 41 (which requires six degrees of freedom for a full characterisation). It will be appreciated that a method embodying the present invention relates not only to characterisation of a specific point (such as the TCP 46) of the tool frame 41 (in three degrees of freedom), but also to characterisation of an axis of the tool frame 41 (in five degrees of freedom, i.e. position and orientation), and even to characterisation of a complete coordinate system of the tool frame 41 (in six degrees of freedom). For example, for the spot welding application mentioned above, only the position of the TCP is typically relevant (i.e. three degrees of freedom), whereas for the arc welding and machining applications the direction of the axis is also relevant (i.e. five degrees of freedom), while for assembly applications the full coordinate system (i.e. six degrees of freedom) would typically be required.

It will also be appreciated that, although the most standard setup for a robot is to have the tool moving and the part fixed, every robotic application can be set up the other way around (i.e. where the robot carries the part and moves it onto a fixed tool). As one example, where there are multiple operations to be performed on the same part, it might be preferable to have a single robot fitted with a gripper (for example as shown in FIG. 2) to hold the part and multiple tools fixed in front of the robot.

An embodiment of the present invention will now be described with reference to FIGS. 5 to 7.

A full calibration routine as described above can be complicated and time consuming, particularly where only a subset of the machine parameters is required, and more particularly where it is only required to determine the offset of the tool centre point of a tool supported on the machine.

An aim of this embodiment is to detect when the tool centre point has drifted, and to recover the correct tool centre point, so that the robot program does not need (or there is less need for) “touch-up”. In this respect, when a robot arm is not accurate because the setup of the part frame and tool frame is not correct, the robot program will not drive the robot tool to the correct position relative to the part. The operator then needs to update the target position recorded in the robot program. This process is called “touch-up” in the robotics world. With a better setup of the part position and of the tool position, the robot is more accurate, hence the relative part/tool position is more accurate and there is less need for correction, or less need for “touch-up”. A “touch-up” is also needed when the machine is modified in some way, for example if the tool frame drifts.

An example setup is shown in FIG. 5, in which a touch tool setter 30, such as the Renishaw RTS or TS27, is fitted with a multi-surface stylus artefact 10. The stylus artefact 10 of FIG. 5 comprises various known geometrical features, such as a cuboidal feature 12 having a plurality of at least partly planar surfaces 14 (four side surfaces and a top surface), and an at least partly cylindrical surface 16. The stylus 10 could also have an at least partly spherical surface (though not in this example).

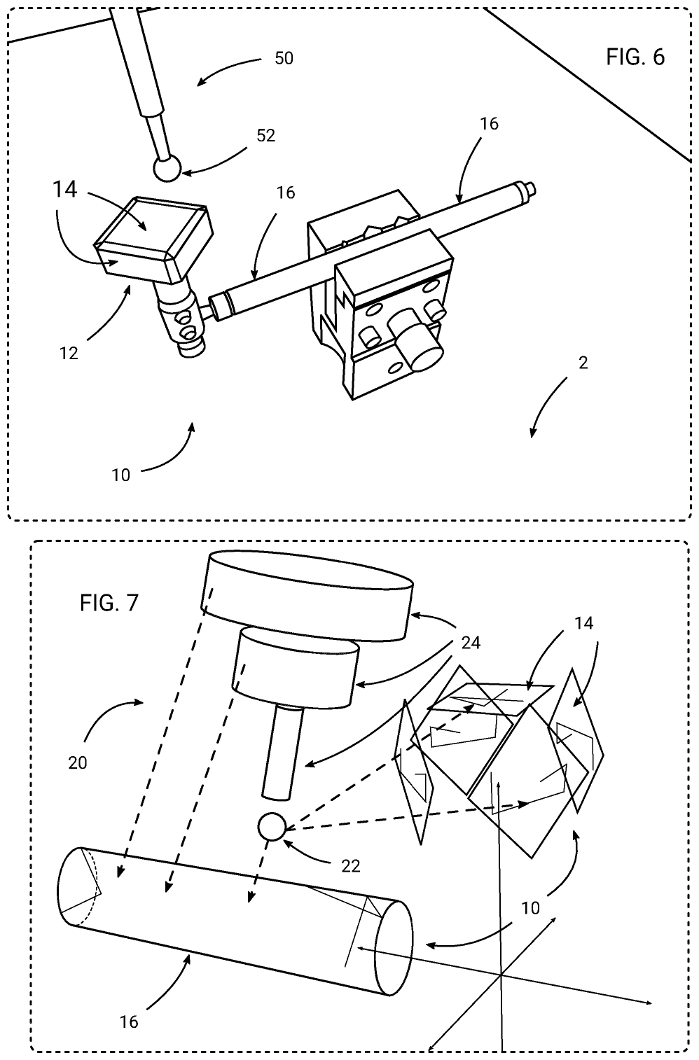

The multi-surface stylus artefact 10, the features of which are also apparent from FIGS. 6 and 7 has various metrological or reference surfaces (i.e. the planar surfaces 14 and the cylindrical surface 16) that can be been measured independently by a calibrated CMM. This procedure is shown being performed in FIG. 6, where the stylus artefact 10 has been fixedly mounted on a fixed platform 2 of the CMM, with a measurement probe 50 (having a stylus tip 52) being moved relative to the fixed platform 2 (and the mounted stylus artefact 10) by the CMM to take dimensional measurements of the various geometrical features 14, 16 of the stylus artefact 10.

A method according to this embodiment involves touching different features of the multi-surface stylus artefact 10 with different parts or surfaces of a tool 20 that is moved by the robot arm 1, as represented by the dashed-line arrows in FIG. 10 (which show examples of points on different surfaces which are brought together into contact one another, i.e. with zero separation between them). For example, point coordinate data for touches between a spherical tip 22 of the tool 20 and planar surfaces 14 of the stylus artefact 10 can be collected, as well as point coordinate data for touches between the cylindrical feature 16 of the stylus artefact 10 and one or more cylindrical features 24 of the tool 20.

The distance between the elements is also recorded. In this respect, there is a nominal geometric model representing the geometry of both the tool 20 and the stylus artefact 10. When a surface of the tool 20 touches a surface of the stylus artefact 10, the robot 1 provides the position of the tool 20. Knowing the position of the stylus artefact 10, the relative position of these surfaces can be witnessed and the surface-to-surface distance can be deduced.

The method of this embodiment is different to known methods in which only a single reference feature on the probe stylus touches the robot tool, or a single feature of the robot tool touches a single reference feature on the probe stylus. An example of such a known method would be probing with a sphere (e.g. the stylus tip of a contact probe). The drift of the TCP position of a robot tool can be large, and when probing with a sphere the drift will induce a significant variation of the touch point normal. Thus, it is impossible with known methods to compare individual touch errors without measuring the whole object.

With this embodiment, the use of various planar or cylindrical features reduces this effect and it becomes possible to check the drift of the TCP position with only three touches. This provides a very quick check of the TCP position. If a TCP variation larger than a required trueness (or some other predetermined threshold) is detected, further points can be probed so that a five degree of freedom transformation can be computed to update the TCP. The TCP can drift over time if, for example, the tool 20 has been knocked slightly out of position, or due to thermal expansion and/or contraction of various parts of the robot 1 mentioned above with reference to FIGS. 1 and 2, or when the robotic tool has been replaced with a new one. As noted above, the model parameters that define the tool frame consist of more than just the tool centre point, which is defined in three degrees of freedom. For example, the position and orientation of a tool frame axis (defined in five degrees of freedom) may also be of importance and may also drift over time. Any number of the model parameters of the tool frame can likewise drift and may benefit from being updated, such that a method embodying the present invention is applicable to updating more than just the tool centre point.

The following steps are performed in this embodiment of the present invention.
(a) first “register” the stylus artefact 10 with a known good TCP (i.e. a TCP that is known to be a reasonable estimate of the true TCP), and record the feature-to-feature distances.
(b) to check for TCP variation, select at least three feature-to-feature distances and probe to collect the distances variations. If the variation is too big (e.g. larger than a predetermined threshold), then:
(c) take a few more touches and collect at least five distance variations in total.
(d) compute a five degree of freedom transformation to update the TCP position in order to recover the feature-to-feature distances that were first registered.

After step (d), the TCP geometry has been repaired or restored, and the TCP behaves exactly as it was before the drift occurred (i.e. the robot 1 positions the tool 20 exactly as it was before the drift). In other words, this aspect of the calibration has been returned to a previous state, i.e. the known good state registered in step (a).

The feature-to-feature distances can also be considered as (or referred to as) errors or error values. This is because, when the two reference surfaces are in contact with one another, it is known that the actual feature-to-feature distance is zero (because the relevant surfaces are known to be in contact, so the separation or distance between them is hence known to be zero). However, the separation as derived from the joint angles (encoder readings) and based on the current calibration (i.e. the current set of model parameters that characterise the geometry of the machine) will inevitably be non-zero because the calibration (as defined by the model parameters) is inevitably not ideal or perfect.

By recording or registering the current set of separations (or errors) in step (a), which is for a state of the machine which is known to be providing a good (or at least acceptable) performance, this enables the multi-surface touch procedure to be repeated at a later time to determine the same or corresponding separations so that a transformation can be applied in order to return the calibration to the previous state (which is known to be a good/acceptable state), at least in respect of one aspect of the calibration (i.e. the TCP). This TCP update or recovery procedure is quicker than performing a full calibration procedure to determine the

TCP from scratch. It will be appreciated that the same type of procedure can be applied to aspects of the calibration (model parameters) other than the TCP.

A method according to this embodiment differs from known methods in at least the following ways:
(i) the method involves the registration between multiple tool surfaces and multiple reference surfaces.
(ii) an update transformation is determined only to recover the previous TCP behaviour, hence touch-up points are still valid, whereas an absolute (full) calibration would destroy the touch-up points.

The registration of part (i) above is also referred herein to as a master stage, with part (ii) also being referred to herein as a recovery stage. As explained above (and as will be explained further below), part (i) involves storing feature-to-feature distances (also referred to herein as errors or separations) and part (ii) involves finding a new set of model parameter values that recover to the same errors as before. Hence it is known that, after recovery, the tool is positioned exactly as it was before the drift.

In this respect, consider that when a robot integrator (or installer) is setting up a robot cell, the robot is not perfect and the setup of the tool and part frames are not particularly accurate. In order to deliver good performance in production, the integrator will need to spend time to touch-up all poses. The principle of master and recovery involves a consideration that after the integrator has done their job, the model is not accurate even though the job has been performed correctly. After there has been a change in the machine (e.g. due to drift, accident, maintenance, etc), the aim is for the robot to position the tool relative to the part at the same position as before. The aim is not to find an accurate set of model parameters as such, but instead the aim is to find a set of model parameters that will retrieve the same position as before.

A method according to an embodiment of the present invention is advantageous because it provides a less costly solution than using a non-contact tool setter, provides a rapid in-production TCP check, and the triggering is robust and reliable compared to optical techniques. Referring to the discussion above regarding the distinction between the tool centre point and the tool frame, it will also be appreciated that a method embodying the present invention can be applied not only to the checking and recovery of the tool centre point (three degrees of freedom), but to the checking and recovery of any number of tool frame parameters that define the tool frame, for example an axis of the tool frame (five degrees of freedom, i.e. position and orientation), or to the checking and recovery of the complete coordinate system of the tool frame (six degrees of freedom).

A method according to an embodiment of the present invention will now be described in more detail with reference to the schematic diagrams shown in FIGS. 8 to 12. This is intended to provide an alternative way of explaining the same method as already described above, with the addition of pictorial representations to assist in an understanding of the concepts underlying an embodiment of the present invention as already set out above.

Starting with FIGS. 8, 9 and 10, these are schematic front views respectively showing master, subsequent and recovery stages of a method embodying the present invention, for a representative one of the plurality of contact points made between the reference surfaces of the stylus artefact 10 and the tool 20. For simplicity of illustration, these figures show only what happens in an X direction.

In the master stage as shown in FIG. 8, the spherical tip 22 of the tool 20 has been moved into contact (in the X direction) with one of the side planar surfaces 14 of the stylus artefact 10, and this contact has been sensed by the touch tool setter 30. The actual separation aₘ between the reference surfaces in this state (i.e. the shortest distance between the two reference surfaces) is therefore known to be zero, because the surfaces are in direct contact with one another. However, based on the current model parameters, the reference surfaces are not expected to be touching and instead the tip 22 is expected to be separated from the surface 14 by a non-zero separation eₘ (which can also be referred to as an error value, because it is a deviation or error from the actual separation aₘ which is known to be zero). The expected position of the tool 20 (i.e. where the machine thinks the tool 20 is based on the current set of model parameters) is illustrated in FIG. 8 by the dotted-lined copy of the tool 20, and the X component of the tool centre point is represented in FIG. 8 as TCP[X]_{M}. Of course, the offset TCP[X]_{M} has been exaggerated for the purposes of this schematic illustration, and in practice would be small. The separation value eₘ is derived from the current model parameters and a geometric model of the stylus artefact 10 and the tool 20, and in this embodiment is determined as the distance between the reference surfaces in a direction that is normal to a tangential contact plane between the surfaces (i.e. normal to the surface of the stylus artefact 10 where contact is made), which is the shortest distance between the two surfaces. The master separation value eₘ is recorded for use in a subsequent recovery stage.

In this respect, after the machine has been in use for some time, the tool centre point may have moved from where it was when the master separation value eₘ was recorded. Therefore, from time to time a recovery procedure can be performed, the first step of which is shown in FIG. 9. As shown in FIG. 9, the tool 20 has been knocked inadvertently during use, and is now mounted at an angle to the flange 3, with the spherical tip 22 displaced to one side in an X direction. The same TCP[X]_{M} is still in use, so the spherical tip 22 is now even further away from where it is expected to be based on the current model parameters. Therefore, in the first step of the recovery procedure as shown in FIG. 9, the contacting procedure of FIG. 8 is again performed, such that the spherical tip 22 of the tool 20 is again moved into contact (in the X direction) with the same reference surface 14 of the stylus artefact 10 in the same place as before, and a separation (or error) value eₛ is again derived. As shown in FIG. 9, the error value eₛ derived this time is different to the master error value eₘ recorded previously.

Accordingly, in the recovery stage as represented in FIG. 10, a new value for the TCP in the X direction is determined which would provide a separation or error value er which matches, or which at least corresponds more closely to, the master (or reference) separation or error value eₘ recorded previously in the master stage of FIG. 8. This is represented in FIG. 10 as a compensation being applied to reduce the TCP value in the X direction from TCP[X]_{M} (as it was previously at the master stage) to TCP[X]_{R} (after the recovery stage). Accordingly, the previous TCP state has been recovered.

FIG. 11 is a schematic front view corresponding to FIG. 8 but for a representative one of the contact points made in a Z direction, while FIG. 12 is a schematic left side view corresponding to FIGS. 8 and 11 but for a representative one of the contact points made in a Y direction. This illustrates how contact is made between multiple reference surfaces in a master stage in order to record a set of separation or error values for use in a later TCP recovery procedure to return the TCP to a known previous state. It will be understood that the contacts illustrated in FIGS. 8, 11 and 12 (for the X, Z and Y directions, respectively) would not be the only contacts made between the various reference surfaces available at the master stage. In this respect, these illustrations are schematic in nature and simplified to illustrate the general principles that are involved in performing a method embodying the present invention, and it would be readily understood how to apply these general principles to a full three-dimensional situation and in more degrees of freedom.

Referring again to FIG. 8, it will be appreciated that the non-zero separation (or error) eₘ determined at the master stage is the consequence of many imperfect model parameters, and not just those associated with the tool centre point (or the tool frame in general). Therefore, the deviation in FIG. 8 between the actual position of the tool 20 (in solid outline) and the expected position of the tool 20 (in dotted outline) is not only due to an imperfect value for TCP[X]ₘ, with the rest of the model parameters (e.g. for the various rotary joints 6, 7) predicting the flange 3 to be exactly where it actually is, as is represented schematically in FIG. 8. However, it should be recalled that the variation in the separation between master and recovery (from eₘ in FIG. 8 to eₛ in FIG. 9) is due only to the changes in the machine. In this example, the only change between master and recovery is in the tool frame, because only the tool 20 has been knocked. Therefore, for the purposes of this illustration it is only the relative compensation applied in FIG. 10 to the TCP (to compensate for the drift of FIG. 9) that is relevant, rather than the absolute value of the TCP. Therefore, TCP[X]ₘ in these drawings can be considered to be a representative TCP rather than the actual TCP, and similarly for TCP[Z]ₘ and TCP[X]ₘ of FIGS. 11 and 12 respectively.

It will be appreciated that recovery of the TCP is relevant to a situation where e.g. the tool 20 is knocked out of position during use. However, the present invention can be applied to recovering model parameters other than those relating just to the tool centre point (or the tool frame more generally), such as those relating to the joint offsets associated with the rotary joints in the robot arm 1. In practice, it would be a matter of knowing what sort of drift is likely to be faced with the model parameters that are to be recovered by the procedure, and adapting the measurement strategy accordingly, but the same principles as described above would apply.

As noted above, the general approach with an embodiment of the present invention is to perform a master calibration when the production is correct. A master set of measurements is stored, and perhaps some identified sensor parameters like the position of the reference artefact. On recovery, the same measurement routine as for the master is performed again, and a new set of model parameters is found that will reproduce (or at least more closely reproduce) the master measurements. At the master stage a limited set of sensor parameters can be identified and the measurement's residual errors are stored. At the recovery stage, some sensor parameters can be identified again, and updated model parameters are determined in order to compute the same residual error as in the master. In this respect, the separation (or error) values can themselves be considered to be the residual error of an optimisation, since an optimisation is performed in order to find the position of the artefact.

It will be appreciated that, to create a point contact between two surfaces, the contact must be “curved to curved” or “curved to flat/planar”, with the curvature being convex (curving outward) rather than concave (curving inward). In particular, the contact must not be “flat/planar to flat/planar” because this would create contact across a surface (planar to planar contact is possible in some circumstances but it brings additional requirements in terms of setup and alignment). However, even where one or both surfaces are curved, care must still be taken to ensure that the two surfaces are mutually adapted (and also arranged relative to one another when contact is made) so as not to create multiple contact points, for example along a line such as would happen when two parallel cylinders make contact along their respective side surfaces or when a cylinder side surface contacts a plane. In the case of two cylindrical surfaces, these can be used to create a suitable point contact between them so long as they are arranged to be non-parallel when they make contact. In the case of a curved surface that contacts a planar surface, the curved surface must be doubly curved (like a sphere). These are just some examples, and the skilled person would understand what properties of the surfaces are required to achieve a point contact between them.

Creating multiple-point contact between surfaces (or even the possibility of this occurring) is considered to be undesirable because there will be uncertainty as to which of the multiple points is actually creating a constraint between the two contacting members. However, it will also be understood that a point of contact in the context of an embodiment of the present invention need not be (and in practice would not be) a mathematical point in the pure sense. Instead, in practice, a point would typically be a small area that approximates a point. The term “point contact” as used herein should therefore be interpreted accordingly as including within its scope a point-like contact such as that which would occur in practice.

In the context of the present invention, a tool or artefact can be considered to have multiple reference surfaces if it has at least one reference surface that is geometrically different and/or distinct from at least one other reference surface of the tool or artefact, for example even if those two reference surfaces merge continuously into one another (without a distinct or noticeable joint between them). Two reference surfaces can be considered to be different and/or distinct from one another in the context of the present invention if they have (or are defined by) different and/or distinct respective geometric properties. For example, opposite sides of the same spherical surface would not be considered in this context to provide multiple (different and/or distinct) reference surfaces because they are defined by the same centre and radius/diameter. On the other hand, a cylinder and a sphere (or other type of convex curved surface) at the end of the cylinder would be considered to provide multiple (different and/or distinct) reference surfaces, because these two parts have different and/or distinct respective geometric properties. The same applies to a planar top surface and a curved side surface of an artefact, which have different and/or distinct respective geometric properties. Two cylinders having different respective diameters, even if arranged coaxially i.e. along the same axis, are considered to provide multiple (different and/or distinct) reference surfaces because the diameter is considered to be a geometric property of a cylinder. Accordingly, it will also be understood that the stylus of a standard contact probe would be considered in this context to have only one reference surface, or at least only one reference surface that is used for contacting a workpiece, i.e. the spherical surface of the stylus tip.

Calibration data collected during the performance of the method can be considered to reflect or represent the (recordable) state of the machine for each rotational position of the rotational movement (or based on some other sampling rate, if not for each rotational position). This type of information (forming part of the calibration data) is also be referred to herein as machine coordinates, which in this context is intended to mean a set of coordinates or values representing the state of the machine (e.g. encoder readings for each joint) for a particular pose. In this respect, the various physical motion axes of a machine, such as the linear axes defined by the extendible legs of a hexapod machine or the rotary axes of an articulated robot arm, can be considered herein to define a machine coordinate system, hence the term machine coordinates.

It will be appreciated that the present invention can be applied not only to calibration of a machine, but also to verification, certification, or performance checking of a machine. The terms calibration method, calibration artefact, calibration member, calibration data, calibration point and so on used herein should be interpreted accordingly in a broad sense, depending on the intended application, and not limited only to calibration as such. In other words, the concepts described herein apply not only to updating of the model parameters (calibration) but also checking or verification of the model parameters (verification or certification). Accordingly, these terms should be understood in the context of calibrating or otherwise characterising the machine. As one example, the term calibration artefact includes within its scope a gauge artefact. The terms target point, target artefact and target member could be used instead of calibration point, calibration artefact and calibration member respectively.

A machine controller for controlling the operation of the coordinate positioning machine may be a dedicated electronic control system and/or may comprise a computer operating under control of a computer program. For example, the machine controller may comprise a real-time controller to provide low-level instructions to the coordinate positioning machine, and a PC to operate the real-time controller. It will be appreciated that operation of the coordinate positioning machine can be controlled by a program operating on the machine, and in particular by a program operating on a coordinate positioning machine controller such as the controller 8. Such a program can be stored on a computer-readable medium, or could, for example, be embodied in a signal such as a downloadable data signal provided from an Internet website. The appended claims are to be interpreted as covering a program by itself, or as a record on a carrier, or as a signal, or in any other form.

1. A method of recovering a master calibration state of a coordinate positioning machine having a first member that is moveable relative to a second member, wherein the geometry of the machine is characterised by a set of model parameters, and wherein the method comprises: (a) controlling the machine to make point contact between multiple reference surfaces of a tool mounted on the first member and multiple reference surfaces of an artefact mounted on the second member; (b) determining the separations between contacting surfaces expected from the current model parameters and recording these as a set of master separations; (c) subsequently performing step (a) again in respect of at least some of the contacts for which corresponding master separations were recorded in step (b);
and (d) updating at least one of the model parameters to provide a closer correspondence to the master separations recorded previously in step (b).

2. A method as claimed in claim 1, wherein the at least one model parameter is or comprises the tool centre point of the tool.

3. A method as claimed in claim 1, wherein an at least nominal geometric model of the tool and/or the artefact is used in step (b) to determine or derive the separations.

4. A method as claimed in claim 1, wherein the master calibration state is a known good calibration state of the machine.

5. A method as claimed in claim 1, wherein, prior to performing step (a) again in full for all contacts for which corresponding master separations were recorded previously in step (b), step (a) is first performed in respect of a subset of those contacts, and only if a measure of variation in the associated expected separations is considered to be above a predetermined threshold or level, then continuing to complete step (a) in respect of the full set of contacts.

6. (canceled)

7. A method as claimed in claim 1, wherein an end surface of the tool is spherical, at least where contact is made with the artefact.

8. A method as claimed in claim 1, wherein a side surface of the tool is cylindrical, at least where contact is made with the artefact.

9. A method as claimed in claim 1, wherein a top surface of the artefact is planar, at least where contact is made with the tool.

10. A method as claimed in claim 1, wherein a side surface of the artefact is planar, at least where contact is made with the tool.

11. A method as claimed in claim 1, comprising using an at least nominal geometric model representing the geometry of the tool and/or the artefact in step (b) and/or step (d).

12. A method as claimed in claim 1, comprising using calibrated dimensional measurements of the artefact in step (b) and/or step (d).

13. A method as claimed in claim 1, wherein the reference surfaces of the artefact are metrological surfaces.

14. A method as claimed in claim 1, comprising sensing contact between the tool and the artefact using a sensor, wherein the sensor is optionally mounted on the second member and is optionally a touch probe or a tool setter.

15. (canceled)

16. A method as claimed in claim 14, wherein the sensor is a contact sensor having a deflectable stylus and a contacting member for contacting an object being sensed, and wherein the artefact is optionally used as the contacting member of the contact sensor.

17.-18. (canceled)

19. A method as claimed in claim 1, wherein the artefact comprises a plurality of planar reference surfaces and a cylindrical reference surface.

20. A method as claimed in claim 1, wherein the tool comprises a plurality of cylindrical reference surfaces and/or a spherical reference surface.

21.-23. (canceled)

24. A method as claimed in claim 1, wherein at least one of the surfaces of the tool and/or the artefact is a revolute surface, for example having at least one revolute axis.

25.-34. (canceled)

35. A method of recovering the tool centre point of a tool mounted to a coordinate positioning machine such as a robot arm, comprising performing a method as claimed in claim 1, and wherein step (d) comprises recovering the tool centre point from the previous calibration state.

36. (canceled)

37. A computer-readable medium having stored therein computer program instructions for controlling a computer or a machine controller to perform one or more steps of a method as claimed in claim 1.

38. A computer or machine controller configured to perform one or more steps of a method as claimed in claim 1.

39.-41. (canceled)
